(19) United States
(12) Patent Application Publication
(10) Pub. No.: US 2014/0333806 A1
(43) Pub. Date: Nov. 13, 2014

(54) Method and device for adapting a filter property of an adaptive color filter and for operating an imager

(71) Applicant: Tobias Ehlgen, Ravensburg (DE)

(72) Inventor: Tobias Ehlgen, Ravensburg (DE)

(21) Appl. No.: 14/240,201

(22) PCT Filed: Jul. 17, 2012
(86) PCT No.: PCT/EP2012/063997

§ 371 Date: Jun. 5, 2014

(30) Foreign Application Priority Data
Aug. 23, 2011 (DE) 10 2011 081 358.6

(51) Int. Cl. H04N 9/04

(52) U.S. Cl. CPC H04N 9/045
USPC 348/273

(57) ABSTRACT

A method for adapting a filter property of an adaptive color filter of an image point of an imager of a camera. The method includes ascertaining a required detection property of the image point, determining a required filter property of the color filter, to implement the required detection property of the image point, and providing a setting signal for setting the filter property of the color filter according to the required filter property.

### BACKGROUND INFORMATION

The present invention relates to a method for adapting a filter property of an adaptive color filter of an image point of an imager of a camera, to a method for operating an imager of a camera of a vehicle, to a corresponding device, as well as to a corresponding computer program product.

In order to be able to ascertain color information with the aid of a camera, different pixels of the imager of the camera are provided with different color filters. In order to be able to obtain a color image, it is, however, necessary to interpolate between the individual pixels. This, in turn, results in measuring inaccuracies when the camera images are evaluated.

The publication DE 102 54 806 B4 shows a method for processing information from at least two information sources in a motor vehicle.

### SUMMARY OF THE INVENTION

Against this background, a method for adapting a filter property of an adaptive color filter of an image point of an imager of a camera, a method for operating an imager of a camera of a vehicle, furthermore devices which use these methods, as well as finally a corresponding computer program product according to the independent claims are proposed by the present invention. Advantageous embodiments result from the particular subclaims and the following description.

With the aid of adaptive color filters, a color sensitivity of an imager of a camera may be continuously adapted. In this way, the imager may be optimally adapted to a scene to be detected.

Advantageously, the adaptive color filter may also be used to prevent an image point from reaching saturation and thus potentially important information from being lost. For example, an erroneous detection of lighting systems which is caused by reflection may be prevented.

The color information detected by the imager may be used in all camera-based measuring algorithms in a vehicle. For example, a piece of color information is necessary for taillight recognition, traffic sign recognition, or for recognizing yellow lane information.

The present invention provides a method for adapting a filter property of an adaptive color filter of an image point of an imager of a camera, including the following steps:

ascertaining a required detection property of the image point;
determining a required filter property of the color filter in order to implement the required detection property of the image point; and
providing a setting signal for setting the filter property of the color filter according to the required filter property.

The camera may be a camera of a vehicle. The camera may be designed to detect an area of the surroundings of the vehicle, e.g., an area ahead of the vehicle, and to continuously generate consecutive images which image the area surroundings.

The imager is designed to convert the light striking the imager into electrical signals. For this purpose, the imager has a plurality of image points or pixels. Each image point is designed to detect light incident on the image point and to provide an image signal which includes a piece of light information of the light incident on the image point. For example, the image signal may include a brightness value or an intensity value of the light incident on the image point. With the aid of the adaptive color filter, the light incident on the image point may be filtered prior to striking a sensor surface of the image point. The color filter is designed in such a way that it allows light of a certain color or wavelength, or of multiple certain colors or wavelengths, to pass or to be filtered out. The color filter may be set to the certain color or the certain colors. The color filter may be set during the operation of the imager. Additionally or alternatively, the permeability of the color filter may be scalable, so that the permeability of the color filter may be, for example, increased or reduced for all colors. The color filter may extend across one image point or across multiple adjacently situated image points. The adaptive color filter may be a so-called microlens. A liquid microlens may be used, for example. Such a liquid microlens may also be used, depending on the specific embodiment, in order to set a focal length of the imager as a function of the temperature and thus as a function of a controller. The adaptive color filter may also be based on technologies for color filters and microlenses for the purpose of monolithic integration into CMOS photo sensor arrays. The required detection property of the image point may refer to a desired color which is to be detected by the image point. The required detection property may, for example, be a function of an instantaneous operating mode of the camera, an instantaneous scenery detected by the camera, or it may be a function of a requirement by an image evaluation device which evaluates the image of the camera. Depending on what detection property of the image point is presently desired, a suitable filter property of the color filter may be set. The suitable filter property of the color filter may be computed, for example, or read out from a look-up table. The setting signal may be an electrical signal which is output to an interface of the adaptive color filter. For example, the setting signal may have a certain voltage value which is suitable to set the required filter property.

According to one specific embodiment, the setting signal may be provided in the step of providing in order to set the filter property of the adaptive color filter which is designed as a microlens. A microlens is suitable as an adaptive filter due to its small dimensions.

In the step of ascertaining, a detection of light of a certain color may be ascertained as the required detection property of the image point. In this case, the required filter property may be determined in the step of determining in such a way that the light of the certain color may pass the color filter. In this way, one and the same image point may, for example, be used to detect white light or light of different colors depending on the set filter property. Advantageously, it is thus possible to reduce the number of image points which are fixedly set to a certain color, or it is possible to completely dispense with such image points which are fixedly set. Individual image points may thus be prevented from supplying image information which is not relevant for a certain area of an image, since a certain color which is detected by the individual image points, for example, is not present in the area of the image or is not interesting for a subsequent image evaluation.

For this purpose, the method may include a step of checking, for example, whether the image point is situated in an area of the imager, with the aid of which a color-relevant object is imaged. In this case, a detection of light of a color of the object may be ascertained as the required detection property in the step of ascertaining. If, for example, it is recognized in the step of checking that a roadway marking is imaged in the area, the color filter of the image point may be set in such a way that the image point is able to detect the color yellow. It may thus be initially checked what color information is interesting and then the image point may be prepared to detect this color information. In this way, the image points of the imager may be continuously adapted to instantaneous needs. The object may be ascertained with the aid of an image evaluation. For this purpose, a position or a movement of a light object may be evaluated, for example. A probable color of the object may also be determined based on the image evaluation. The probable color may be verified by setting the filter property of the color filter. For example, the color filter may be set for this purpose in such a way that the probable color is able to pass the color filter and other colors are filtered out.

Also, a required measuring sensitivity of the image point may be ascertained as the required detection property of the image point in the step of ascertaining. In this case, a permeability of the color filter may be determined according to the required measuring sensitivity as the required filter property in the step of determining. The measuring sensitivity may be used to define how sensitively the image point responds to incident light. If the measuring sensitivity is low, the image point responds only at a higher light intensity when compared to a higher measuring sensitivity. In this way, the image point may be, for example, adapted to different global or local brightnesses or contrasts in a scenery detected by the imager. If an image point is located, for example, within the area of influence of a reflection having high light intensity, the measuring sensitivity of this image point may be reduced. The measuring sensitivity of adjacent image points, which are not located within the area of influence of the reflection, may in contrast remain unchanged.

In this case, the method may include a step of recognizing an imminent saturation of the image point. In the step of ascertaining, the required measuring sensitivity may be reduced when the imminent saturation is recognized. In this way, the image information may be prevented from being lost due to a saturation of the image point. The imminent saturation may be recognized, for example, by evaluating one of the image signals output by the image point.

The present invention furthermore provides a method for operating an imager of a camera of a vehicle, including the following steps:

evaluating an image of the imager for ascertaining an image area of the image which is relevant with regard to a color analysis; and
setting the filter property of at least one adaptive color filter of at least one image point which is situated in an area of the imager assigned to the relevant image area.

This method makes it possible to continuously adapt an imager to a changing scenery or changing requirements of assistance systems of the vehicle.

Furthermore, the present invention provides a device which is designed to carry out or implement the steps of the method according to the present invention in appropriate devices. This embodiment variant of the present invention in the form of a device also makes it possible to achieve the object underlying the present invention rapidly and efficiently.

In the present case, a device may be understood to mean an electrical device which processes sensor signals and outputs control signals as a function thereof. The device may have an interface which may be designed as hard- and/or software. In the case of a hardware design, the interfaces may, for example, be a part of a so-called system ASIC, which includes various functions of the device. It is, however, also possible that the interfaces are independent, integrated circuits or are at least partially made of discrete components. In the case of a software design, the interfaces may be software modules which are present on a microcontroller in addition to other software modules, for example.

A computer program product having program code is also advantageous, which may be stored on a machine-readable carrier, such as a semiconductor memory, a hard disk memory, or an optical memory, and is used for carrying out the method according to one of the specific embodiments described above, when the program is executed on a computer or a device.

The present invention is elucidated below in greater detail, as an example, on the basis of the appended drawings.

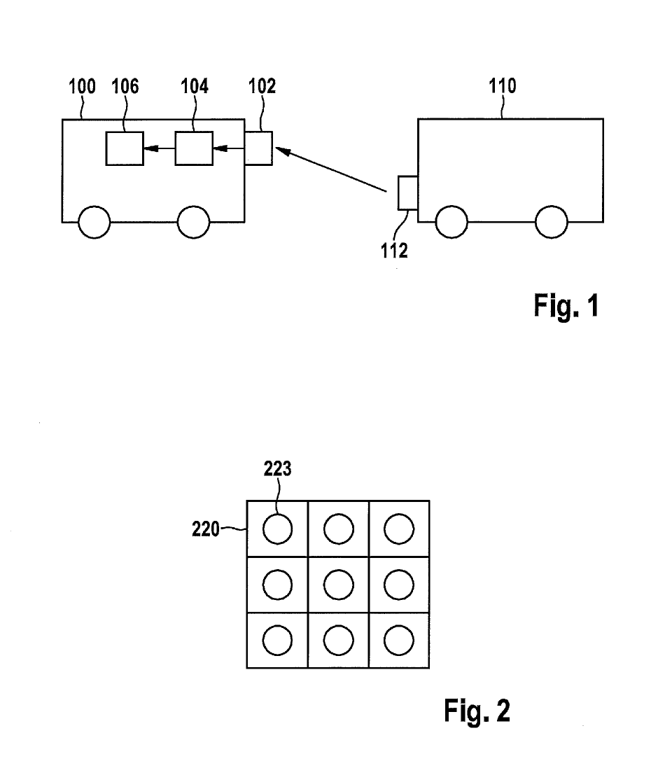

FIG. 1 shows a schematic illustration of a vehicle according to one exemplary embodiment of the present invention;

FIG. 2 shows a schematic illustration of an imager according to one exemplary embodiment of the present invention;

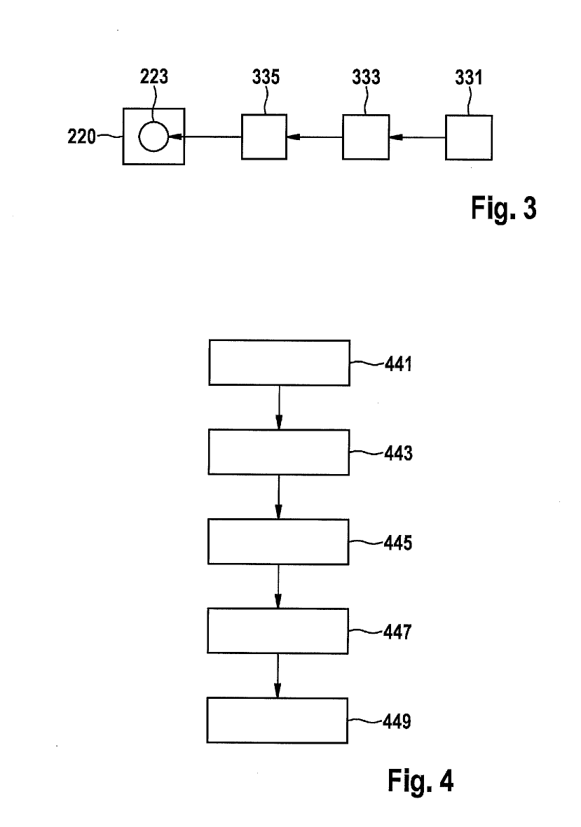

FIG. 3 shows a block diagram of a device for setting a settable color filter according to one exemplary embodiment of the present invention; and

FIG. 4 shows a flow chart of one exemplary embodiment of the present invention.

In the following description of preferred exemplary embodiments of the present invention, the elements which are illustrated in the various figures and appear to be similar are identified with identical or similar reference numerals; a repetitive description of these elements is dispensed with.

FIG. 1 shows a schematic illustration of a vehicle 100 according to one exemplary embodiment of the present invention. Vehicle 100 has a camera 102, an image evaluation device 104, and a driver assistance system 106. Another vehicle 110 is located in the area ahead of vehicle 100. The other vehicle 110 has a red taillight 112. Driver assistance system 106 is a system for which recognition of taillight 112 of the other vehicle 110 is relevant. Taillight 112 is here to represent any colored object whose color is relevant for any system 106 of vehicle 100.

If the other vehicle 110 is in a detection area of camera 102, camera 102 may generate an image in which taillight 112 is imaged. According to this exemplary embodiment, light which is emitted by taillight 112 is detected by camera 102. Image evaluation device 104 is designed to evaluate the image of camera 102 in order to determine an image area in which taillight 112 is imaged. If brightness stages or shades of gray which are different in each case are illustrated in the image, image evaluation device 104 is not able to differentiate under certain circumstances whether taillight 112 is a taillight which emits a red light or a headlight which emits a white light. If the color of taillight 112 is imaged in the image, taillight 112 may be unambiguously classified as such by image evaluation device 104 due to the red color. In order to be able to illustrate the red color of taillight 112 in the image, the camera may be designed to adapt a detection property of the image points, which image taillight 112, of an imager of camera 102 in such a way that red light may be detected.

FIG. 2 shows a schematic illustration of an imager or a section of an imager according to one exemplary embodiment of the present invention. The imager may be used in the camera mentioned in FIG. 1. The imager has a plurality of image points 220 or pixels. Nine image points 220 are shown here as an example which are situated adjacently to one another in three rows and three columns. An adaptive color filter 223 is assigned to each image point 220. Color filters 223 are each situated in a beam path of a light beam striking image points 220. Thus, each of image points 220 is struck by light which has been filtered through the one color filter 223 which is assigned to particular image point 220.

Each of color filters 223 has an interface via which a filter property of particular color filter 223 may be set. By setting the filter property, the light which strikes assigned image point 220 may be influenced.

If, for example, a taillight of a vehicle is imaged by the central of shown image points 220 at a first point in time, the filter property of color filter 223 which is assigned to central image point 220 may be set in such a way that color filter 223 allows red light to pass.

If, for example, a section of a roadway marking is imaged by the central of shown image points 220 at a second point in time, the filter property of color filter 223 which is assigned to central image point 220 may be set in such a way that color filter 223 allows yellow light to pass, so that it may be recognized by an image evaluation device which evaluates the image signals of image points 220, for example, that the roadway marking is a yellow-marked roadway marking in the area of a construction site, for example.

According to this exemplary embodiment, each of adaptive color filters 223 is implemented as a liquid microlens. Here, color filter 223 is generated per image point 220 with the aid of an electrowetting process.

Apart from the implementation using liquid lenses, a color filter may also be implemented mechanically. Here, multiple filters may be put mechanically on top of one another. Such a color filter may be established for all or for several image points 220 at the same time.

FIG. 3 shows a device for adapting a filter property of an adaptive color filter 223 of an image point 220 of an imager of a camera according to one exemplary embodiment of the present invention. The camera may be a camera shown in FIG. 1.

The device is designed to generate a setting signal for setting the filter property of color filter 223 based on a required detection property of image point 220 and to output this signal via an interface to color filter 223 or to a control device for controlling the filter property of color filter 223. For this purpose, the device has a detection device 331, a determination device 333, and a provision device 335.

Detection device 331 is designed to ascertain a required detection property of image point 220. The required detection property may, for example, be ascertained based on an evaluation of an image which was generated previously by the imager. Detection device 331 is designed to output a piece of information about the required detection property to determination device 333. Determination device 333 is designed to determine a required filter property of color filter 223 based on the required detection property. With the aid of the required filter property, image point 220 may be operated in such a way that it has the required detection property. In order to determine the required filter property, determination device 333 may be designed to access a memory in which filter properties of color filter 223 are stored, each of which is assigned to different detection properties of image point 220. Determination device 333 is designed to output a piece of information about the required filter property to provision device 335. Provision device 335 is designed to generate the setting signal for setting the filter property of color filter 223 based on the piece of information about the required filter property of color filter 223 and to output this signal to color filter 223 via the interface.

Color filter 223 is designed to receive the setting signal and to change its filter property in response to the setting signal in order to implement the required filter property.

For each color filter 223 of the imager, an individual setting signal may be determined and provided. A setting signal may also be provided for a group of color filters 223 which are assigned to image points having the same detection property.

According to one exemplary embodiment, the device for adapting a filter property is implemented as a processor unit or an arithmetic unit. With the aid of the processor unit, the color permeability of microlenses 223 may be changed. As a result, it is possible, among other things, to activate corresponding lenses 223 in areas in which a colored object is assumed. In this way, a higher color resolution may be achieved in these areas.

The processor unit is designed to receive an image having filtered and unfiltered pixels as an input signal. The filtering degree of the image may be established beforehand. The processor unit is furthermore designed to carry out an estimation as to whether the light objects are red or white objects, based on the movement and the position of the light objects in the image. In order to back up this assumption or estimation, the processor unit is designed to change the color permeability to thus obtain information about the actual color of the light objects. In order to be able to change the color permeability, color filters 223 of the imager may be set accordingly. In particular, those color filters 223 may be changed which are assigned to the area of the image in which the light objects are located whose color is being instantaneously ascertained.

The permeability of corresponding lenses 223 may also be controlled. Therefore, the saturation risk of individual image points 220 may be controlled. Adaptive filters 223 may thus be used to prevent saturation in camera-based lighting systems. The saturation may be recognized in the processor unit. For this purpose, the processor unit is designed to slowly change the filter property of color filter 223 if the brightness value of an image point 220 has reached a certain threshold and to observe the corresponding behavior of the pixel value or the brightness value of image point 220.

FIG. 4 shows a flow chart of a method for operating an imager of a camera of a vehicle according to one exemplary embodiment of the present invention. The camera may be a camera described based on FIG. 1. In a step 441, an image of the camera is evaluated in order to ascertain an image area which is to be evaluated with regard to a color which is presumably or certainly present in the image area. In a step 443, those image points of the imager are selected which are located in the image area. Subsequently, filter properties of the adaptive color filters which are assigned to the image points selected in step 443 are set in such a way that the color to be evaluated in the image area may be detected by the selected image points. For this purpose, required detection properties of the selected image points may be ascertained in a step 445 as a function of the color to be evaluated. In a step 447, required filter properties of the color filters of the selected image points may be determined for the purpose of implementing the required detection properties of the selected image points. In a step 449, a setting signal for setting the filter property of the color filter of the selected image points is output according to the required filter property. If different filter properties are required for the color filters, different setting signals may be provided in step 449. The method may be carried out for one or multiple image areas of the image.

The exemplary embodiments described and shown in the figures have only been selected as examples. Different exemplary embodiments may be combined with each other in their entirety or with regard to their individual characteristics. Also, one exemplary embodiment may be supplemented with characteristics of another exemplary embodiment. Furthermore, method steps according to the present invention may be repeated and executed in a sequence different from the one described.

1-9. (canceled)

10. A method for adapting a filter property of an adaptive color filter of an image point of an imager of a camera, the method comprising:
ascertaining a required detection property of the image point;
determining a required filter property of the color filter in order to implement the required detection property of the image point; and
providing a setting signal for setting the filter property of the color filter according to the required filter property.

11. The method of claim 10, wherein the setting signal is provided to set the filter property of the adaptive color filter, which is configured as a microlens.

12. The method of claim 10, wherein in the ascertaining, a detection of light of a certain color is ascertained as the required detection property of the image point, and wherein in the determining, the required filter property is determined so that the light of the certain color may pass the color filter.

13. The method of claim 12, further comprising:
checking whether the image point is situated in an area of the imager, with the aid of which a color-relevant object is imaged;
wherein in the ascertaining, a detection of light of a color of the object is ascertained as the required detection property.

14. The method of claim 10, wherein in the ascertaining, a required measuring sensitivity of the image point is ascertained as the required detection property of the image point, and wherein in the determining, a permeability of the color filter is determined as the required filter property according to the required measuring sensitivity.

15. The method of claim 14, further comprising:
recognizing an imminent saturation of the image point;
wherein in the ascertaining, the required measuring sensitivity is reduced when the imminent saturation is recognized.

16. A method for operating an imager of a camera of a vehicle, the method comprising:
evaluating an image of the imager for ascertaining an image area of the image which is relevant with regard to a color analysis; and
setting a filter property of at least one adaptive color filter of at least one image point which is situated in an area of the imager which is assigned to the relevant image area.

17. A device for adapting a filter property of an adaptive color filter of an image point of an imager of a camera, comprising:
an ascertaining arrangement to ascertain a required detection property of the image point;
a determining arrangement to determine a required filter property of the color filter in order to implement the required detection property of the image point; and
a providing arrangement to provide a setting signal for setting the filter property of the color filter according to the required filter property.

18. A computer readable medium having a computer program, which is executable by a processor, comprising:
a program code arrangement having program code product having program code for adapting a filter property of an adaptive color filter of an image point of an imager of a camera, by performing the following:
ascertaining a required detection property of the image point;
determining a required filter property of the color filter in order to implement the required detection property of the image point; and
providing a setting signal for setting the filter property of the color filter according to the required filter property.
